(19) United States
(12) Patent Application Publication
(10) Pub. No.: US 2025/0201032 A1
(43) Pub. Date: Jun. 19, 2025

(54) VEHICLE COMMUNICATION SYSTEM AND VEHICLE COMMUNICATION DEVICE

(71) Applicant: HONDA MOTOR CO., LTD., Tokyo (JP)

(72) Inventor: Hidekazu SHINTANI, Tokyo (JP)

(73) Assignee: HONDA MOTOR CO., LTD., Tokyo (JP)

(21) Appl. No.: 18/983,421

(22) Filed: Dec. 17, 2024

(30) Foreign Application Priority Data
Dec. 18, 2023 (JP) 2023-213303

(51) Int. Cl. G07C 5/00; B60L 58/12; G07C 5/08; H04W 4/40

(52) U.S. Cl. CPC G07C 5/008; B60L 58/12; G07C 5/0808; H04W 4/40; B60L 2260/52

(57) ABSTRACT

A vehicle communication system includes a vehicle equipped with a battery that supplies electric power to a drive source, and a server that communicates with the vehicle. The vehicle includes a communication device that collects predetermined vehicle data and uploads the vehicle data to the server. The server includes a server-side storage device that stores the vehicle data uploaded from the vehicle. The communication device of the vehicle communicates with the server via mobile data communication on a pay-as-you-go basis and fixed-line data communication on a flat-rate basis. In a state where the communication device of the vehicle is allowed to conduct the fixed-line data communication with the server, the communication device uploads the vehicle data to the server via the fixed-line data communication.

### CROSS-REFERENCE TO RELATED APPLICATIONS

This application is based on and claims priority under 35 USC 119 from Japanese Patent Application No. 2023-213303 filed on Dec. 18, 2023, the entire content of which is incorporated herein by reference.

### TECHNICAL FIELD

The present disclosure relates to a vehicle communication system and a vehicle communication device.

### BACKGROUND ART

In recent years, researches and developments have been conducted on a secondary battery which contributes to improvement in energy efficiency in order to allow more people to have access to affordable, reliable, sustainable and advanced energy. The secondary battery is mounted on a vehicle for example, and supplies electric power to a motor as a drive source.

In the related art, systems are known that transmit and receive data between a communication device provided in a vehicle and a device external to the vehicle. For example, JP2014-155400A discloses a charging system in which wireless communication is performed between an electric automobile equipped with a battery and a charging station, and the vehicle receives diagnostic information of the charging station.

In some cases, a communication device of a vehicle collects travel data, data related to a battery, and the like and uploads the data to an external server to manage a vehicle state including failure diagnosis, for example. Such data has a large volume, and for example, when the data is uploaded from the vehicle to the server via mobile data communication on a pay-as-you-go basis, while the vehicle is traveling, communication cost increases, and a burden on a user of the vehicle increases.

### SUMMARY OF INVENTION

The present disclosure provides a vehicle communication system and a vehicle communication device capable of reducing communication cost when predetermined vehicle data is transmitted to a server.

A first aspect of the present disclosure relates to a vehicle communication system, including:
a vehicle equipped with a battery that supplies electric power to a drive source; and
a server configured to communicate with the vehicle,
in which the vehicle includes a communication device configured to collect predetermined vehicle data and upload the vehicle data to the server,
the server includes a server-side storage device that stores the vehicle data uploaded from the vehicle,
the communication device of the vehicle is configured to communicate with the server via mobile data communication on a pay-as-you-go basis and fixed-line data communication on a flat-rate basis, and
in a state where the communication device of the vehicle is allowed to conduct the fixed-line data communication with the server, the communication device uploads the vehicle data to the server via the fixed-line data communication.

A second aspect of the present disclosure relates to a vehicle communication device installed in a vehicle including a battery that supplies electric power to a drive source, and configured to collect predetermined vehicle data and upload the vehicle data to a server,
in which the vehicle communication device is configured to communicate with the server via mobile data communication on a pay-as-you-go basis and fixed-line data communication on a flat-rate basis, and
in a state where the vehicle communication device is allowed to conduct the fixed-line data communication with the server, the vehicle communication device uploads the vehicle data to the server via the fixed-line data communication.

According to the aspects of the present disclosure, it is possible to reduce communication cost when predetermined vehicle data is transmitted to a server.

### BRIEF DESCRIPTION OF DRAWINGS

Exemplary embodiment(s) of the present invention will be described in detail based on the following figures, wherein:

FIG. 1 is a configuration diagram of a communication system 1 according to an embodiment of the present disclosure;

FIG. 2 is a block diagram illustrating a configuration of a vehicle 20;

FIG. 3 is a flowchart of upload processing of vehicle data by a TCU 40;

FIG. 4 is a diagram illustrating a first example of upload processing of vehicle data 90;

FIG. 5 is a diagram illustrating a second example of the upload processing of the vehicle data 90; and

FIG. 6 is a diagram illustrating a third example of the upload processing of the vehicle data 90.

### DESCRIPTION OF EMBODIMENTS

Hereinafter, a vehicle communication system and a vehicle communication device according to an embodiment of the present disclosure will be described with reference to the accompanying drawings.

### (Overall Configuration of Vehicle Communication System)

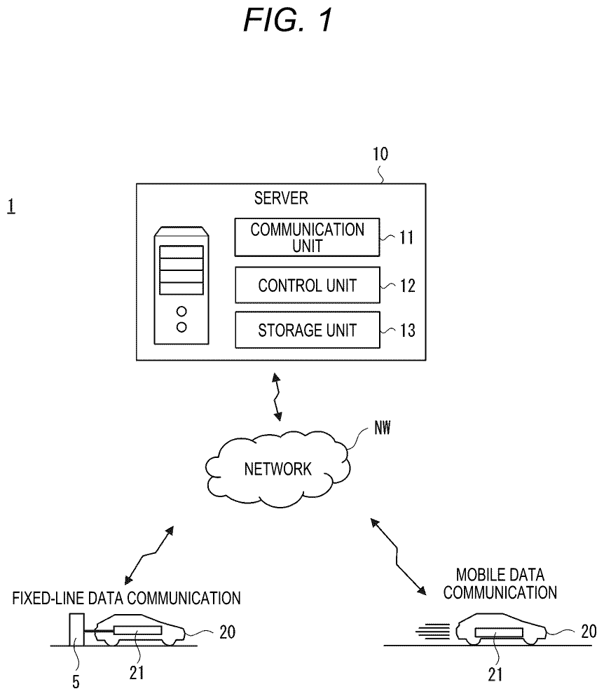

FIG. 1 is a configuration diagram of a communication system 1. The communication system 1 includes a server 10 and a vehicle 20. The server 10 and the vehicle 20 are configured to communicate with each other via a network NW.

The server 10 is a device that performs information processing using a device (including the vehicle 20) connected to the network NW as a client. The server 10 includes a communication unit 11 that communicates with the device via the network NW and transmits and receives predetermined data, a control unit 12 that performs predetermined processing such as analysis on the received data, and a storage unit 13 that stores the received data. The control unit 12 may be implemented by a computer including a central processing unit (CPU), a read only memory (ROM), a random access memory (RAM), an I/O, a bus, and the like. The storage unit 13 includes and is implemented by, for example, a non-volatile storage medium, and stores various data, programs, and the like. The control unit 12 reads a program stored in the storage unit 13 to perform predetermined processing, for example.

The vehicle 20 is an electric vehicle equipped with a battery 21 that supplies electric power to an electric motor serving as a drive source. The vehicle 20 is, for example, a battery type electric automobile or a plug-in hybrid vehicle, and is configured such that the battery 21 can be charged by being supplied with electric power from a charging equipment 5 serving as an external power supply. The charging equipment 5 is provided in, for example, a parking lot of a commercial facility, a charging spot, a home, or the like.

The vehicle 20 is configured to communicate with the server 10 via mobile data communication on a pay-as-you-go basis, and fixed-line data communication on a flat-rate basis. The mobile data communication is, for example, a cellular communication scheme such as 3G (third generation mobile communication system), 4G (fourth generation mobile communication system), LTE (long term evolution), and 5G (fifth generation mobile communication system), and performs wireless communication with the server 10 via a base station (not illustrated) during traveling of the vehicle 20. The fixed-line data communication is a communication scheme using a fixed communication line on a flat-rate basis, and for example, when the vehicle 20 is connected to the charging equipment 5 via a charging cable and is charged, the vehicle 20 is wirelessly connected to the server 10 using a fixed communication line of the charging equipment 5. For example, when the vehicle 20 is parked at home, the vehicle 20 performs wireless communication with the server 10 using Wi-Fi (registered trademark) or the like connected to a fixed communication line contracted at home.

### (Configuration of Vehicle)

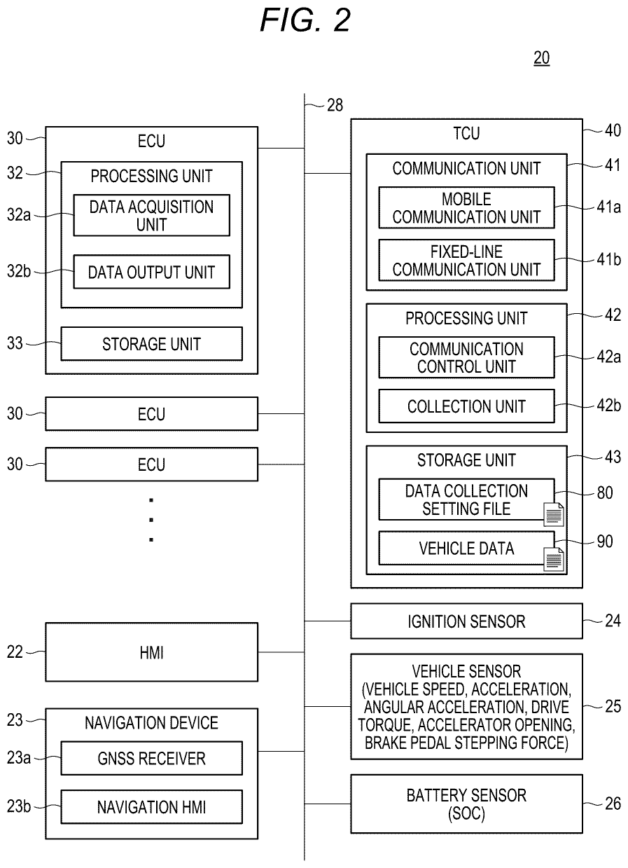

FIG. 2 is a block diagram illustrating a configuration of the vehicle 20. The vehicle 20 includes, for example, a human machine interface (HMI) 22, a navigation device 23, an ignition sensor 24, a vehicle sensor 25, a battery sensor 26, a plurality of electronic control units (ECU) 30, and a telematics control unit (TCU) 40, which are configured to communicate with each other via an in-vehicle network 28. The in-vehicle network 28 is, for example, a multiplex communication line such as a controller area network (CAN) communication line, a serial communication line, or a wireless communication network.

The HMI 22 presents various types of information to an occupant of the vehicle 20 and receives an input operation from the occupant. The HMI 22 includes various display devices, a speaker, a buzzer, a touch panel, a switch, a key, and the like.

The navigation device 23 includes, for example, a global navigation satellite system (GNSS) receiver 23a and a navigation HMI 23b. The navigation device 23 stores map information in a storage device such as a hard disk drive (HDD) or a flash memory. The GNSS receiver 23a specifies a position of the vehicle 20 based on a signal received from a GNSS satellite. The navigation HMI 23b includes a display device, a speaker, a touch panel, a key, and the like. The navigation HMI 23b may be partially or entirely unified with the HMI 22 described above.

The ignition sensor 24 is a sensor that detects whether an ignition power supply of the vehicle 20 is in an on state or an off state. The ignition sensor 24 outputs data indicating whether the ignition power supply is in an on state or an off state to a predetermined ECU 30.

The vehicle sensor 25 includes a vehicle speed sensor that detects a travel speed (also referred to as a “vehicle speed”) of the vehicle 20, an acceleration sensor that detects an acceleration, an angular speed sensor that detects an angular speed around a vertical axis, an azimuth sensor that detects a direction of the vehicle 20, and the like. The vehicle sensor 25 also includes sensors that detect a drive torque, an accelerator opening, a brake pedal stepping force, and the like.

The battery sensor 26 includes a current sensor that detects a current flowing from the battery 21, a voltage sensor that detects a voltage of the battery 21, and the like. Detection values obtained by the current sensor and the voltage sensor are used to calculate a state of charge (hereinafter referred to as SOC) of the battery 21, for example. The battery sensor 26 may also include a temperature sensor that detects a temperature of the battery 21.

Each ECU 30 includes, for example, a processing unit 32 and a storage unit 33, and controls the vehicle 20 and various devices included in the vehicle 20. The processing unit 32 includes a data acquisition unit 32a and a data output unit 32b as functional units. The data acquisition unit 32a acquires detection results of the ignition sensor 24, the vehicle sensor 25, the battery sensor 26, and the like, and stores the detection results in the storage unit 33. Specifically, the data acquisition unit 32a acquires the on state or off state of ignition, the vehicle speed, the acceleration, the angular acceleration, the drive torque, the accelerator opening degree, the brake pedal stepping force, the SOC of the battery 21, and the like based on the detection results of the sensors 24 to 26. The data output unit 32b transmits various types of data stored in the storage unit 33 to the TCU 40 via the in-vehicle network 28 based on a command from the TCU 40.

The TCU 40 communicates with the server 10 via the network NW. The TCU 40 includes a communication unit 41, a processing unit 42, and a storage unit 43.

The communication unit 41 includes a mobile communication unit 41a and a fixed-line communication unit 41b. The mobile communication unit 41a includes communication hardware related to a communication scheme of mobile communication on the above-described pay-as-you-go basis, and performs wireless communication with the server 10 via the network NW under control of the processing unit. The fixed-line communication unit 41b includes communication hardware related to a communication scheme using the fixed communication line on the above-described flat-rate basis, and performs wireless communication with the server 10 via the network NW under control of the processing unit 42.

The processing unit 42 is, for example, a CPU, and includes a communication control unit 42a and a collection unit 42b as functional units. The communication control unit 42a controls the communication unit 41 based on a data collection setting file 80 transmitted from the server 10. The collection unit 42b collects predetermined vehicle data 90 from each ECU 30 based on the data collection setting file 80, and uploads the vehicle data 90 to the server 10 at a predetermined timing.

The data collection setting file 80 is a file that defines a type of data to be collected, a timing of collection, a timing of uploading the collected data to the server 10, and the like. The data collection setting file 80 is transmitted from the server 10 to the vehicle 20 at any timing under a state where the server 10 and the vehicle 20 can communicate with each other, and is stored in the storage unit 43 of the TCU 40, for example.

In the present embodiment, the vehicle data 90 refers to non-control data that is not used for control operation of the vehicle 20, and is data that is not required to be immediately uploaded to the server 10 after being collected by the collection unit 42b in principle. The vehicle data 90 is data with a relatively large volume. The vehicle data 90 may include, for example, diagnostic information for diagnosing states of various devices included in the vehicle 20. Specific contents of the vehicle data 90 will be described later.

The storage unit 43 includes a nonvolatile storage area that stores programs and data in a nonvolatile manner. The storage unit 43 stores a program executed by the processing unit 42, the vehicle data 90, the data collection setting file 80, and the like in a nonvolatile manner. The storage unit 43 may include a nonvolatile storage device such as an HDD or a Solid State Drive (SSD).

### (Upload Processing to Server)

As described above, since the vehicle data 90 is data with a relatively large volume, when the TCU 40 uploads the vehicle data 90 collected by the collection unit 42b to the server 10 via the mobile data communication, communication cost increases as compared with the fixed-line data communication. When the vehicle 20 is traveling, a communication state of the mobile data communication may change every moment, and the upload of the vehicle data 90 via the mobile data communication is likely to be unstable.

When the TCU 40 is in a state of being allowed to conduct the fixed-line data communication with the server 10, the vehicle data 90 is transmitted to the server 10 via the fixed-line data communication. Specifically, in the data collection setting file 80 transmitted from the server 10, it is defined that the vehicle data 90 is uploaded to the server 10 only when communication with the server 10 via the fixed-line data communication is possible in principle as an upload condition of data. In accordance with the upload condition defined in the data collection setting file 80, the TCU 40 uploads the vehicle data 90 to the server 10 in the state where the TCU 40 is allowed to conduct the fixed-line data communication with the server 10. In this way, the communication cost can be reduced. The vehicle data 90 can be stably uploaded to the server 10.

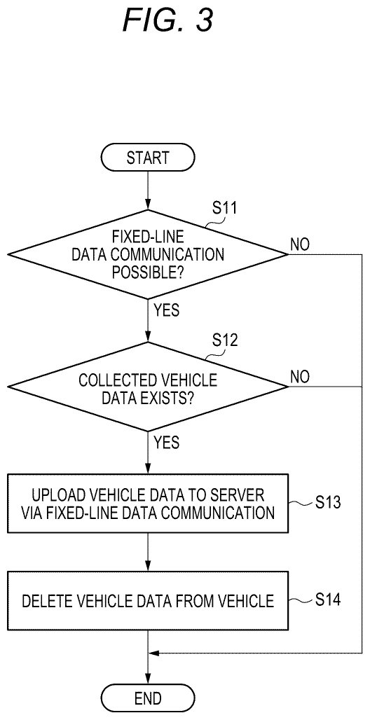

FIG. 3 shows an example of a flowchart of the upload processing of uploading the vehicle data 90 to the server 10 by the TCU 40. For example, the TCU 40 repeatedly executes the flowchart in a predetermined control cycle.

The TCU 40 determines whether the fixed-line data communication is possible (step S11). If the fixed-line data communication is impossible (step S11: NO), the TCU 40 ends the flowchart. Under this case, when there is collected vehicle data 90, the TCU 40 continues to store the vehicle data 90 in the storage unit 43.

If the fixed-line data communication is possible (step S11: YES), the TCU 40 determines whether there is collected vehicle data 90 (step S12). If there is no collected vehicle data 90 (step S12: NO), the TCU 40 ends the flowchart.

If there is collected vehicle data 90 (step S12: YES), the TCU 40 uploads the vehicle data 90 to the server 10 via the fixed-line data communication (step S13).

After uploading the vehicle data 90, the TCU 40 deletes the vehicle data 90 stored in the storage unit 43 (step S14). Accordingly, it is possible to prevent vehicle data with a large volume from being continuously stored in the storage unit 43 and the capacity of the storage unit 43 from being oppressed.

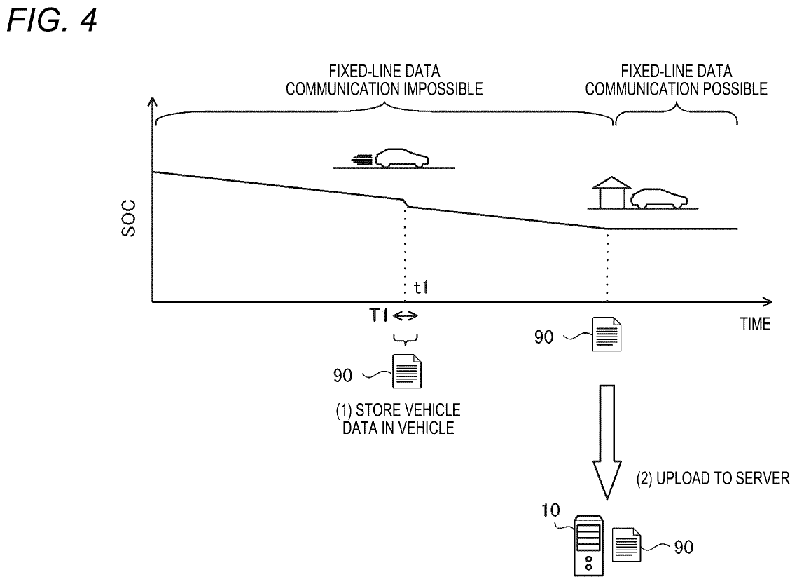

FIG. 4 is a diagram illustrating a first example of the upload processing of the vehicle data 90 to the server 10. In the first example, the vehicle data 90 is data collected before and after a timing t1 at which a change in the SOC of the battery 21 is large. When there is a timing t1 at which the change in the SOC of the battery 21 is larger than other times during traveling of the vehicle 20, the TCU 40 collects data including battery-related information and traveling-related information in a predetermined period T1 including the timing t1 as the vehicle data 90. Here, the predetermined period T1 is, for example, a period of 15 seconds before and after the timing t1, and a time interval for collecting data is 10 [ms] to 1 [s]. Note that the various types of data constituting the vehicle data 90 are always acquired by the data acquisition unit 32a of the ECU 30 at a predetermined time interval during startup of the vehicle 20, and are stored for at least a predetermined period. Therefore, the TCU 40 can collect the vehicle data 90 before the timing t1.

The traveling-related information is, for example, information including at least one of temporal change information on the vehicle speed, the acceleration, the angular acceleration, the drive torque, the accelerator opening, and the brake pedal stepping force in the period T1 or traveling location information. The traveling-related information may include information on an outside air temperature. The battery-related information is information including at least temporal change information on the SOC of the battery 21 in the period T1. Since the vehicle data 90 including such temporal change information has a relatively large volume, for example, when the vehicle data 90 is uploaded to the server 10 via the mobile data communication while the vehicle 20 is traveling, an increase in the communication cost or failure of upload may occur.

In a state where the TCU 40 is not allowed to conduct the fixed-line data communication with the server 10, the TCU 40 continues to store the vehicle data 90 collected in the period T1 in the storage unit 43. For example, when the vehicle 20 is parked at home and becomes communicable with the server 10 using Wi-Fi connected to a fixed communication line, the TCU 40 uploads the vehicle data 90 stored in the storage unit 43 to the server 10 via the fixed-line data communication. Accordingly, the communication cost can be reduced, and the vehicle data 90 can be stably uploaded to the server 10.

The vehicle data 90 in the period T1 may be used for increasing accuracy of calculation of the cruising distance of the vehicle 20. Specifically, the server 10 learns a calculation logic for calculating a change amount of the SOC of the battery 21 according to a driving behavior of the user of the vehicle 20 based on the vehicle data 90 uploaded from the vehicle 20. The server 10 calculates the cruising distance of the vehicle 20 based on the change amount of the SOC of the battery 21 calculated by the calculation logic. By preparing a calculation logic finely customized for each user, it is possible to calculate a cruising distance with high accuracy for each user. Note that the server 10 may transmit the calculation logic obtained by the learning to the vehicle 20, and the vehicle 20 may be configured to calculate the cruising distance.

The highly accurate cruising distance calculated in this manner may be displayed on a display device included in the HMI 22 or the navigation HMI 23b of the vehicle 20, or may be displayed on a predetermined application screen of a portable terminal used by the user, or may be displayed on a map, specifically, may be displayed as an area at which the vehicle 20 is highly possible to arrive with a current remaining amount of the battery 21.

The vehicle data 90 in the period T1 may be used to improve a location, a road, or a facility that causes a decrease in the SOC of the battery 21. Specifically, based on the vehicle data 90 uploaded from the vehicle 20, the server 10 specifies a location (for example, a road or a facility) where the vehicle 20 travels at the timing t1 at which the SOC significantly decreases, and analyzes a tendency of a gradient, a curvature, a road surface material, or the like at the location where the SOC significantly decreases. Accordingly, an operator of the server 10 can provide an analysis result to a local government or the like and contribute to improvement of a road or a facility where the SOC may greatly decrease.

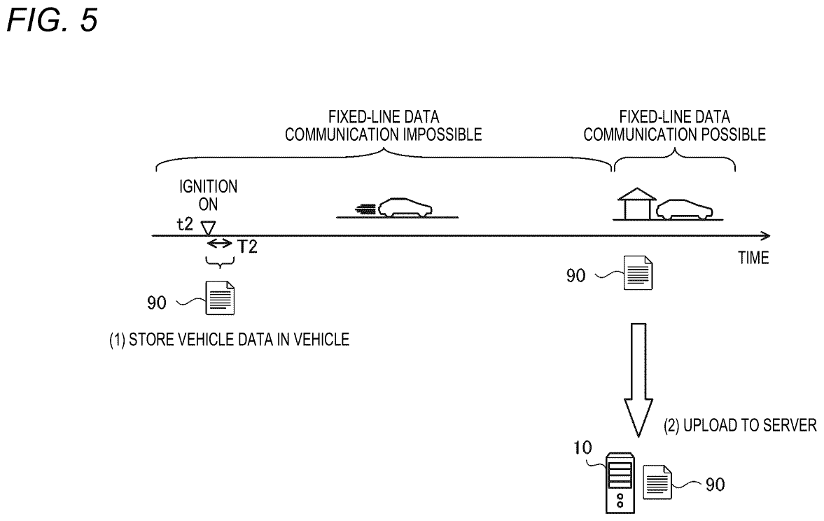

FIG. 5 is a diagram illustrating a second example of the upload processing of the vehicle data 90. In the second example, the vehicle data 90 is data collected during startup of the vehicle 20. Specifically, the vehicle data 90 is data including startup information acquired during a period T2 from a timing t2 at which the ignition of the vehicle 20 is in an on state until a predetermined time (for example, 15 seconds) elapses. The TCU 40 collects the vehicle data 90 acquired in the period T2. A time interval for collecting data is, for example, 10 [ms] to 1 [s].

The startup information is, for example, information including at least one of the temperature, the state of charge, the current temporal change information, or the voltage temporal change information of the battery 21 acquired in the period T2. The startup information may include information related to a state of the vehicle 20, such as the temperature of the vehicle 20. Since the vehicle data 90 including such temporal change information has a relatively large volume, when the vehicle data 90 is uploaded to the server 10 via the mobile data communication, an increase in the communication cost or failure of upload may occur.

In the state where the TCU 40 is not allowed to conduct the fixed-line data communication with the server 10, the TCU 40 continues to store the vehicle data 90 acquired in the period T2 during startup of the vehicle 20 in the storage unit 43. For example, when the vehicle 20 is parked at home and becomes communicable with the server 10 using Wi-Fi connected to a fixed communication line, the TCU 40 uploads the vehicle data 90 stored in the storage unit 43 to the server 10 via the fixed-line data communication. Accordingly, the communication cost can be reduced, and the vehicle data 90 can be stably uploaded to the server 10.

The vehicle data 90 including the startup information may be used, for example, to specify occurrence of an abnormality in the vehicle 20. Specifically, the server 10 communicates with a plurality of vehicles via the network NW, and stores vehicle data 90 including startup information of each vehicle as big data in the storage unit 13. The server 10 specifies the vehicle in which an abnormality occurs based on the startup information of the plurality of vehicles.

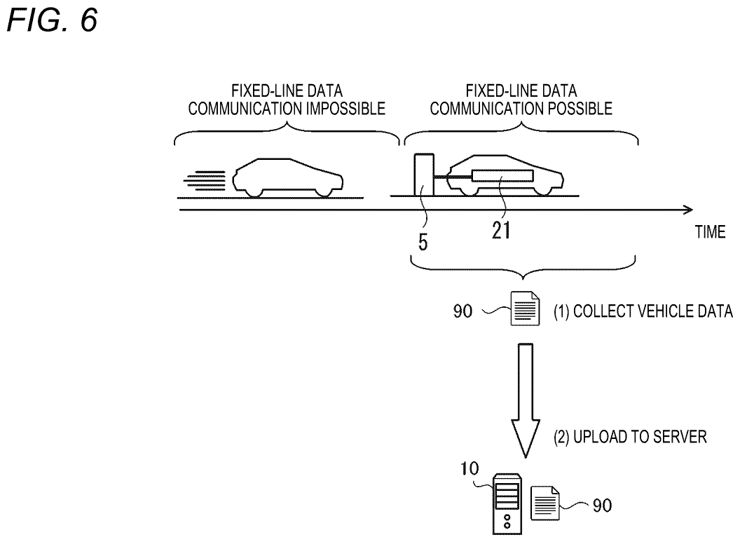

FIG. 6 is a diagram illustrating a third example of the upload processing of the vehicle data 90. In the third example, the vehicle data 90 is data collected when the vehicle 20 is connected to the charging equipment 5. That is, the vehicle 20 starts to collect the vehicle data 90 in response to charging by the charging equipment 5. The vehicle data 90 is, for example, information including the temperature, the state of charge, the current temporal change information, and the voltage temporal change information of the battery 21 as described above. The vehicle data 90 may include various types of data stored in each ECU 30 during traveling of the vehicle 20. The TCU 40 performs wired communication with the charging equipment 5 via a communication line provided in a charging cable of the charging equipment 5, and uploads the vehicle data 90 to the server 10 using a fixed communication line of the charging equipment 5. Note that the TCU 40 may communicate with the charging equipment 5 not via wired communication but via wireless communication, and in this case, the TCU 40 uploads the vehicle data 90 to the server 10 using the fixed communication line of the charging equipment 5.

Note that in the third example, when other vehicle data 90 is already stored in the storage unit 43, the other vehicle data 90 that is already collected may be uploaded to the server 10 using the fixed communication line of the charging equipment 5 in addition to the vehicle data 90 that is started to be collected in response to the charging by the charging equipment 5.

### Modification

In the above-described embodiment, the TCU 40 uploads the vehicle data 90 to the server 10 only when communication with the server 10 via the fixed-line data communication is possible based on the upload condition of data defined in the data collection setting file 80 in principle, but the present invention is not limited thereto.

For example, when the TCU 40 is not connected to a fixed communication line for a long period, a state in which the vehicle data 90 stored in the storage unit 43 is not uploaded to the server 10 continues for a long period, or a data volume of the vehicle data 90 stored in the storage unit 43 increases. Therefore, in the data collection setting file 80, an upper limit value of a connection waiting time to a fixed communication line and/or an upper limit value of a cache amount may be defined. When the connection waiting time to a fixed communication line and/or the cache amount exceeds the upper limit value, the TCU 40 may be able to upload the vehicle data 90 to the server 10 via the mobile data communication.

For example, in the data collection setting file 80, information included in the vehicle data 90 whose volume is less than a predetermined threshold may be defined to be immediately uploaded to the server 10 via the mobile data communication after being collected.

For example, when there is an instruction to immediately collect and/or upload the vehicle data 90 from the server 10 or the like, the TCU 40 may immediately collect and/or upload the vehicle data 90 to the server 10 via the mobile data communication.

Although an embodiment of the present disclosure has been described above with reference to the accompanying drawings, it is needless to say that the present invention is not limited to the embodiment. It is apparent that those skilled in the art can conceive of various modifications and alterations within the scope described in the claims, and it is understood that such modifications and alterations naturally fall within the technical scope of the present invention. In addition, the constituent elements in the above embodiments may be freely combined without departing from the gist of the invention.

For example, in principle, although several specific examples of the vehicle data 90 uploaded to the server 10 via the fixed-line data communication have been given in the above-described embodiment, the vehicle data 90 may include various types of information other than the above-described specific examples. For example, the vehicle data 90 may include information which has a relatively large volume and does not need to be immediately uploaded, such as image data of an in-vehicle camera or shape positioning data by a radar.

In the present description, at least the following matters are described. In the parentheses, the corresponding constituent elements and the like in the above embodiment are shown as examples, but the present invention is not limited thereto.
(1) A vehicle communication system (communication system 1), including:
a vehicle (vehicle 20) equipped with a battery (battery 21) that supplies electric power to a drive source; and
a server (server 10) configured to communicate with the vehicle,
in which the vehicle includes a communication device (TCU 40) configured to collect predetermined vehicle data (vehicle data 90) and upload the vehicle data to the server,
the server includes a server-side storage device (storage unit 13) that stores the vehicle data uploaded from the vehicle,
the communication device of the vehicle is configured to communicate with the server via mobile data communication on a pay-as-you-go basis and fixed-line data communication on a flat-rate basis, and
in a state where the communication device of the vehicle is allowed to conduct the fixed-line data communication with the server, the communication device uploads the vehicle data to the server via the fixed-line data communication.

According to (1), the communication cost can be reduced by uploading the vehicle data to the server via the fixed-line data communication on the flat-rate basis rather than the mobile data communication on the pay-as-you-go basis.
(2) The vehicle communication system according to (1),
in which the vehicle further includes a vehicle-side storage device (storage unit 43) that stores the vehicle data, and
in a state where the communication device of the vehicle is not allowed to conduct the fixed-line data communication with the server, the communication device continues to store the vehicle data in the vehicle-side storage device.

According to (2), in the state where the communication with the server via the fixed-line data communication is not possible, the communication cost can be reduced by continuously storing the vehicle data in the vehicle-side storage device without uploading the vehicle data to the server via the mobile data communication.
(3) The vehicle communication system according to (2),
in which the vehicle data includes traveling-related information related to traveling of the vehicle and battery-related information related to the battery during a first period (period T1) including a timing when a state of charge (SOC) of the battery changes significantly.

According to (3), since the vehicle data obtained in the first period including the timing at which the change in the state of charge of the battery is large is stored in the server, the server can improve the calculation accuracy of the cruising distance on the basis of the vehicle data, and can analyze the location where the change in the state of charge is caused.
(4) The vehicle communication system according to (3),
in which the traveling-related information includes at least one of temporal change information on a vehicle speed, an acceleration, an angular acceleration, a drive torque, an accelerator opening, and a brake pedal stepping force, or traveling location information, and
the battery-related information includes at least temporal change information on the state of charge of the battery.

According to (4), even when the vehicle data is data with large volume including temporal change information, the communication device uploads the vehicle data to the server via the fixed-line data communication on the flat-rate basis, not via the mobile data communication on the pay-as-you-go basis, thereby reducing the communication cost. When the traveling-related information includes the traveling location information, the server can specify a location where a change in the state of charge of the battery is large and use an improvement measure or the like of the location.
(5) The vehicle communication system according to (3) or (4),
in which the server learns a calculation logic for calculating a change amount of the state of charge of the battery according to a driving behavior of a user of the vehicle or a traveling route of the vehicle, based on the vehicle data uploaded from the vehicle, and
the server or the vehicle calculates a cruising distance of the vehicle based on the change amount of the state of charge of the battery calculated by the calculation logic.

According to (5), the server can calculate the cruising distance with high accuracy based on the stored information. The cruising distance customized for each user of the vehicle can be calculated.
(6) The vehicle communication system according to any one of (1) to (5),
in which the vehicle data includes startup information acquired during a second period (period T2) from startup of the vehicle until a predetermined time elapses.

According to (6), it is possible to upload the information acquired during startup of the vehicle in which a change in behavior is likely to appear to the server via the fixed-line data communication. Accordingly, the server can control the vehicle with high accuracy.
(7) The vehicle communication system according to (6),
in which the startup information includes at least one of a temperature, the state of charge, current temporal change information, or voltage temporal change information of the battery acquired during the second period.

According to (7), the information related to the battery acquired during startup of the vehicle in which a change in behavior is likely to appear can be uploaded to the server via the fixed-line data communication. Accordingly, the server can control the battery with high accuracy.
(8) The vehicle communication system according to (6) or (7),
in which the server specifies a vehicle in which an abnormality occurs, based on the startup information uploaded from a plurality of vehicles.

According to (8), it is possible to specify a vehicle in which an abnormality occurs from big data including startup information of a plurality of vehicles.
(9) The vehicle communication system according to any one of (1) to (8),
in which the vehicle data includes diagnostic information for diagnosing a state of a device provided in the vehicle.

According to (9), it is possible to upload diagnostic information, which is non-control data that is not used for the control operation of the vehicle, to the server via the fixed-line data communication.
(10) The vehicle communication system according to any one of (2) to (9),
in which the communication device uploads the vehicle data stored in the vehicle-side storage device to the server via the fixed-line data communication, and then deletes the vehicle data from the vehicle-side storage device.

According to (10), it is possible to prevent the data volume of the vehicle-side storage device from being oppressed.
(11) A vehicle communication device (TCU 40) installed in a vehicle (vehicle 20) including a battery (battery 21) that supplies electric power to a drive source, and configured to collect predetermined vehicle data (vehicle data 90) and upload the vehicle data to a server (server 10),
in which the vehicle communication device is configured to communicate with the server via mobile data communication on a pay-as-you-go basis and fixed-line data communication on a flat-rate basis, and
in a state where the vehicle communication device is allowed to conduct the fixed-line data communication with the server, the vehicle communication device uploads the vehicle data to the server via the fixed-line data communication.

According to (11), the communication cost can be reduced by uploading the vehicle data to the server via the fixed-line data communication on the flat-rate basis rather than the mobile data communication on the pay-as-you-go basis.

What is claimed is:

1. A vehicle communication system, comprising:
a vehicle equipped with a battery that supplies electric power to a drive source; and
a server configured to communicate with the vehicle,
wherein the vehicle includes a communication device configured to collect predetermined vehicle data and upload the vehicle data to the server,
the server includes a server-side storage device that stores the vehicle data uploaded from the vehicle,
the communication device of the vehicle is configured to communicate with the server via mobile data communication on a pay-as-you-go basis and fixed-line data communication on a flat-rate basis, and
in a state where the communication device of the vehicle is allowed to conduct the fixed-line data communication with the server, the communication device uploads the vehicle data to the server via the fixed-line data communication.

2. The vehicle communication system according to claim 1,
wherein the vehicle further includes a vehicle-side storage device that stores the vehicle data, and
in a state where the communication device of the vehicle is not allowed to conduct the fixed-line data communication with the server, the communication device continues to store the vehicle data in the vehicle-side storage device.

3. The vehicle communication system according to claim 2,
wherein the vehicle data includes traveling-related information related to traveling of the vehicle and battery-related information related to the battery during a first period including a timing when a state of charge of the battery changes significantly.

4. The vehicle communication system according to claim 3,
wherein the traveling-related information includes at least one of temporal change information on a vehicle speed, an acceleration, an angular acceleration, a drive torque, an accelerator opening, and a brake pedal stepping force, or traveling location information, and
the battery-related information includes at least temporal change information on the state of charge of the battery.

5. The vehicle communication system according to claim 3,
wherein the server learns a calculation logic for calculating a change amount of the state of charge of the battery according to a driving behavior of a user of the vehicle or a traveling route of the vehicle, based on the vehicle data uploaded from the vehicle, and
the server or the vehicle calculates a cruising distance of the vehicle based on the change amount of the state of charge of the battery calculated by the calculation logic.

6. The vehicle communication system according to claim 1,
wherein the vehicle data includes startup information acquired during a second period from startup of the vehicle until a predetermined time elapses.

7. The vehicle communication system according to claim 6,
wherein the startup information includes at least one of a temperature, the state of charge, current temporal change information, or voltage temporal change information of the battery acquired during the second period.

8. The vehicle communication system according to claim 6,
wherein the server specifies a vehicle in which an abnormality occurs, based on the startup information uploaded from a plurality of vehicles.

9. The vehicle communication system according to claim 1,
wherein the vehicle data includes diagnostic information for diagnosing a state of a device provided in the vehicle.

10. The vehicle communication system according to claim 2,
wherein the communication device transmits the vehicle data stored in the vehicle-side storage device to the server via the fixed-line data communication, and then deletes the vehicle data from the vehicle-side storage device.

11. A vehicle communication device installed in a vehicle including a battery that supplies electric power to a drive source, and configured to collect predetermined vehicle data and upload the vehicle data to a server,
wherein the vehicle communication device is configured to communicate with the server via mobile data communication on a pay-as-you-go basis and fixed-line data communication on a flat-rate basis, and
in a state where the vehicle communication device is allowed to conduct the fixed-line data communication with the server, the vehicle communication device uploads the vehicle data to the server via the fixed-line data communication.
